(19) United States
(12) Patent Application Publication
(10) Pub. No.: US 2020/0400709 A1
(43) Pub. Date: Dec. 24, 2020

(54) CABLE AND HIGH TEMPERATURE RESISTANT PIEZOELECTRIC ACCELERATION SENSOR

(71) Applicant: FATRI (Xiamen) Technologies Co., Ltd., Xiamen City (CN)

(72) Inventors: Yongzhong NIE, Xiamen City (CN); Wenjie LIU, Xiamen City (CN)

(73) Assignee: FATRI (Xiamen) Technologies Co., Ltd., Xiamen City (CN)

(21) Appl. No.: 16/749,082

(22) Filed: Jan. 22, 2020

(30) Foreign Application Priority Data
Jun. 21, 2019 (CN) 201920939643.0

(51) Int. Cl. G01P 15/09; H01R 4/62; H01B 11/00; H01R 4/02

(52) U.S. Cl. CPC G01P 15/09; H01R 4/023; H01B 11/00; H01R 4/625

(57) ABSTRACT

The present disclosure relates to a cable and a high temperature resistant piezoelectric acceleration sensor. The cable comprises a high temperature connection terminal, a low temperature connection terminal, and a high temperature resistant wire segment and a low temperature wire segment located between the high temperature connection terminal and the low temperature connection terminal. The high temperature connection terminal is connected to the high temperature resistant wire segment, and the low temperature connection terminal is connected to the low temperature wire segment; the high temperature resistant wire segment and the low temperature wire segment are connected by a connecting member; and the low temperature wire segment has a bending radius smaller than that of the high temperature resistant wire segment, and the cable can be connected to a high temperature device via the high temperature connection terminal, and connected to a normal temperature device via the low temperature connection terminal.

### CROSS REFERENCE TO RELATED APPLICATION

This application claims priority to Chinese Patent Application No. 201920939643.0, filed on Jun. 21, 2019, which is hereby incorporated by reference in its entirety.

### TECHNICAL FIELD

The present disclosure relates to a technical field of acceleration sensor technologies, and particularly relates to a cable and a high temperature resistant piezoelectric acceleration sensor.

### BACKGROUND

A high temperature piezoelectric acceleration sensor is a device for measuring a vibration signal of a system in a high temperature environment, and a cable for transmitting an electrical signal generated by the high temperature piezoelectric acceleration sensor also needs to be able to tolerate higher temperatures.

The current cable that can tolerate higher temperatures has a problem that a bending radius thereof is too large to be routed easily during installation. Further, it is not easy for an output end of the cable to be connected to a connector, and the cable has a high cost.

### SUMMARY

Embodiments of the present disclosure provide a cable and a high temperature resistant piezoelectric acceleration sensor, wherein the cable has a smaller bending radius, can be easily routed during installation and has a lower cost.

On one aspect, the embodiments of the present disclosure disclose a cable, comprising: a high temperature connection terminal, a low temperature connection terminal, and a high temperature resistant wire segment and a low temperature wire segment located between the high temperature connection terminal and the low temperature connection terminal, wherein the high temperature connection terminal is connected to the high temperature resistant wire segment, and the low temperature connection terminal is connected to the low temperature wire segment; the high temperature resistant wire segment and the low temperature wire segment are connected by a connecting member; and the low temperature wire segment has a bending radius smaller than that of the high temperature resistant wire segment, and the cable can be connected to a high temperature device via the high temperature connection terminal, and can be connected to a normal temperature device via the low temperature connection terminal.

According to one aspect of the embodiments of the present disclosure, the high temperature resistant wire segment is made of INCONEL 600 or INCONEL 718, and the high temperature resistant wire segment has a temperature tolerance from 400° C. to 500° C.

According to one aspect of the embodiments of the present disclosure, the high temperature resistant wire segment and the high temperature connection terminal are connected by a tin soldering, and the low temperature wire segment and the low temperature connection terminal are connected by a tin soldering.

According to one aspect of the embodiments of the present disclosure, the connecting member comprises a case, wherein the case comprises openings at both ends and an internal accommodating space for containing an end portion of the high temperature resistant wire segment and an end portion of the low temperature wire segment; and the end portion of the high temperature resistant wire segment and the end portion of the low temperature wire segment are connected by a nickel strip within the accommodating space.

According to one aspect of the embodiments of the present disclosure, the end portion of the high temperature resistant wire segment is connected to the nickel strip by a tin soldering, and the end portion of the low temperature wire segment is connected to the nickel strip by a tin soldering.

According to one aspect of the embodiments of the present disclosure, a high temperature resistant sealing portion is disposed within the accommodating space of the case, and the sealing portion is adapted to fix positions of the end portion of the high temperature resistant wire segment and the end portion of the low temperature wire segment connected to each other, and isolate the end portions from an exterior of the connecting member.

According to one aspect of the embodiments of the present disclosure, a first limiting portion and a second limiting portion are respectively provided at the openings on both ends of the case, wherein the first limiting portion is adapted to fix the high temperature resistant wire segment, and the second limiting portion is adapted to fix the low temperature wire segment; the first limiting portion comprises a limiting protrusion, and the limiting protrusion is provided with a first through hole for fixing the high temperature resistant wire segment; and the second limiting portion comprises an end cover, and the end cover is provided with a second through hole for fixing the low temperature wire segment.

According to one aspect of the embodiments of the present disclosure, the first limiting portion comprises one limiting protrusion, and the one limiting protrusion is provided with a recessed region on one side for fixing the high temperature resistant wire segment; or the first limiting portion comprises a plurality of limiting protrusions, and the plurality of limiting protrusions are arranged in an annular form for fixing the high temperature resistant wire segment, wherein at least one of the plurality of limiting protrusions is provided with a recessed region on a side facing the remaining limiting protrusions, for fixing the high temperature resistant wire segment.

According to one aspect of the embodiments of the present disclosure, a fastener is provided on an outer peripheral surface of the limiting protrusion, and the fastener is adapted to shorten a perimeter of an outer peripheral surface of the first limiting portion.

On a second aspect, the embodiments of the present disclosure disclose a high temperature resistant piezoelectric acceleration sensor, comprising: a high temperature charge output device and a cable according to any of the above embodiments, wherein the high temperature connection terminal of the cable is connected to a signal output terminal of the high temperature charge output device.

In the cable provided by the embodiments of the present disclosure, the high temperature resistant wire segment and the low temperature wire segment are connected by the connecting member, and the cable can receive a signal from the high temperature environment and output the signal to the low temperature environment. Further, since the bending radius of the low temperature wire segment is smaller than the bending radius of the high temperature resistant wire segment, the overall bending radius of the cable is relatively small. Therefore, the cable can be easily routed and laid during installation, and thus can adapt to various installation environments. Moreover, the overall cost of the cable can be reduced by using the low temperature wire segment.

### BRIEF DESCRIPTION OF THE DRAWINGS

In order to illustrate the technical solutions of the embodiments of the present disclosure more clearly, the drawings to be used in the embodiments of the present disclosure will be briefly described below. It is obvious that the drawings described below are only some embodiments of the present disclosure, and the person skilled in the art can obtain other drawings based on these drawings without paying any creative work.

FIG. 1 is a schematic diagram showing a configuration of a cable according to an embodiment of the present disclosure.

FIG. 2 is a partial cross-sectional view of the configuration as shown in FIG. 1.

FIG. 3 is a front view showing a configuration of a connecting member in a cable according to an embodiment of the present disclosure.

FIG. 4 is a right side view showing a configuration of a connecting member in a cable according to another embodiment of the present disclosure.

In the drawings:

1—high temperature connection terminal, 2—low temperature connection terminal, 3—high temperature resistant wire segment, 4—low temperature wire segment, 5—high temperature device, 6—normal temperature device, 7—connecting member;

70—case, 71—first limit portion, 72—second limit portion; 711—limiting protrusion, 712—first through hole, 713—recessed region; 721—end cover.

### DETAILED DESCRIPTION

Below, embodiments of the present disclosure will be further described in detail with reference to the drawings and embodiments. The detailed description of the embodiments and the drawings are intended to exemplarily illustrate the principles of the present disclosure and are not intended to limit the scope of the present disclosure. That is, the present disclosure is not limited to the described embodiments.

In the description of the present disclosure, it should be noted that, unless otherwise stated, the terms “first”, “second” and the like are used for descriptive purposes only and are not to be construed as indicating or implying relative importance; the meaning of “a plurality of” is two or more; the orientations or positional relationships indicated by the terms “inner”, “outer”, “top”, “bottom” and the like are based on orientations or positional relationships as shown in the drawings, are merely for the purpose of describing the present disclosure and simplifying the description, and are not intended to indicate or imply that the device or component referred to has a particular orientation, is constructed and operated in a particular orientation, and therefore cannot be understood to be a limitation of the present disclosure.

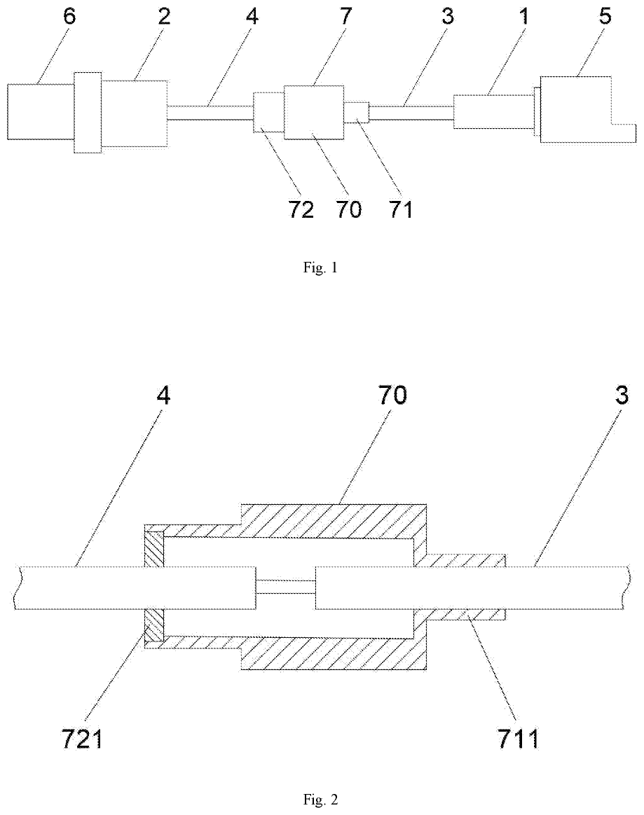

Referring to FIG. 1, a cable according to an embodiment of the present disclosure includes a high temperature connection terminal 1, a low temperature connection terminal 2, a high temperature resistant wire segment 3 and a low temperature wire segment 4 located between the high temperature connection terminal 1 and the low temperature connection terminal 2. The high temperature connection terminal 1 is connected to the high temperature resistant wire segment 3, and the low temperature connection terminal 2 is connected to the low temperature wire segment 4. The high temperature resistant wire segment 3 and the low temperature wire segment 4 are connected by a connecting member 7. The low temperature wire segment 4 has a bending radius smaller than that of the high temperature resistant wire segment 3. The cable can be connected to a high temperature device 5 via the high temperature connection terminal 1, and can be connected to a normal temperature device 6 via the low temperature connection terminal 2.

In the present embodiment, the high temperature resistant wire segment 3 is connected to the high temperature connection terminal 1, the low temperature wire segment 4 is connected to the low temperature connection terminal 2, and the high temperature resistant wire segment 3 and the low temperature wire segment 4 are connected by the connecting member 7. As such, the cable can be connected to the high temperature device 5 via the high temperature connection terminal 1 and connected to the normal temperature device 6 via the low temperature or normal temperature connection terminal. Thus, the cable can be used in a high temperature environment, and transmit a signal to a low temperature or a normal temperature environment. On the one hand, a signal reception from the high temperature environment can be achieved, and on the other hand, the signal can be output and collected in a low temperature or normal temperature region. The bending radius of the low temperature wire segment 4 is smaller than that of the high temperature resistant wire segment 3, and the low temperature wire segment 4 is cooperated with the high temperature resistant wire segment 3. Thus, a bending radius of the entire cable is relatively small, which facilitates route of the cable during installation. Therefore, the cable can be laid easily and can adapt to a variety of installation environments. Moreover, an overall cost of the cable can be reduced by using the low temperature wire segment 4. Further, a length of the low temperature wire segment 4 and that of the high temperature resistant wire segment 3 can be selected according to the installation environments. Particularly, the length of the low temperature wire segment 4 can be selected, to avoid a waste caused by using the high temperature resistant wire segment 3 in the low temperature or normal temperature environment, which can reduce the cost reasonably. Furthermore, the low temperature wire segment 4 is relatively soft and not easily damaged, and thus can be connected to the low temperature connection terminal 2 more conveniently, resulting in an easy connection process and a lower installation cost.

As an alternative embodiment, the high temperature resistant wire segment 3 is made of INCONEL 600 or INCONEL 718, and the high temperature resistant wire segment 3 has a temperature tolerance from 400° C. to 500° C. The property of the high temperature resistant wire segment 3 of the present embodiment will not be affected and can perform signal transmission normally in the environment from 400° C. to 500° C.

As an alternative embodiment, the high temperature resistant wire segment 3 and the high temperature connection terminal 1 are connected by a tin soldering, and the low temperature wire segment 4 and the low temperature connection terminal 2 are connected by a tin soldering. In the present embodiment, the high temperature resistant wire segment 3 and the high temperature connection terminal 1 are connected by the tin soldering, which does not affect the transmission of the signal, and also has a high connection stability; the low temperature wire segment 4 and the low temperature connection terminal 2 are connected by the tin soldering, which can achieve a stable connection and signal transmission.

As an alternative embodiment, the connecting member 7 includes a case 70, which includes openings at both ends and an internal accommodating space for accommodating an end portion of the high temperature resistant wire segment 3 and an end portion of the low temperature wire segment 4. The end portion of the high temperature resistant wire segment 3 and the end portion of the low temperature wire segment 4 are connected by a nickel strip within the accommodating space. The connecting member 7 of the present embodiment connects the high temperature resistant wire segment 3 to the low temperature wire segment 4, and in the accommodating space of the case 70, the end portion of the high temperature resistant wire segment 3 is connected to the nickel strip, and the end portion of the low temperature wire segment 4 is connected to the same nickel strip. Therefore, the connection of the high temperature resistant wire segment 3 and the low temperature wire segment 4 can be achieved, and a normal signal transmission between the high temperature resistant wire segment 3 and the low temperature wire segment 4 can be ensured by the connection using the nickel strip.

As an alternative embodiment, the end portion of the high temperature resistant wire segment 3 is connected to the nickel strip by a tin soldering, and the end portion of the low temperature wire segment 4 is connected to the nickel strip by a tin soldering. In the present embodiment, both of the high temperature resistant wire segment 3 and the low temperature wire segment 4 are connected to the nickel strip by the tin soldering, which can result in a stable connection.

As an alternative embodiment, the accommodating space of the case 70 is provided with a high temperature resistant sealing portion for fixing and isolating the end portions of the high temperature resistant wire segment 3 and the low temperature wire segment 4 connected to each other from an exterior of the connecting member 7. The sealing portion of the present embodiment may be made of an epoxy resin. The epoxy resin can be filled into the accommodating space of the case 70, and form the sealing portion after solidification. As such, a relative position of the end portions of the high temperature resistant wire segment 3 and the low temperature wire segment 4 connected to each other can be fixed by the sealing portion, which can enhance the connection of the high temperature resistant wire segment 3 to the low temperature wire segment 4 by the connecting member 7. Meanwhile, the sealing portion can isolate the end portions of the high temperature resistant wire segment 3 and the low temperature wire segment 4 from the exterior of the connecting member 7, thereby reducing influence of the exterior on the signal transmission. Further, since the epoxy resin has good heat resistance, an environmental compatibility of the sealing portion can be improved.

Please continue to refer to FIG. 2, as an alternative embodiment, the openings at the two ends of the case 70 are respectively provided with a first limiting portion 71 for fixing the high temperature resistant wire segment 3 and a second limiting portion 72 for fixing the low temperature wire segment 4. Combining with FIG. 4, the first limiting portion 71 includes a limiting protrusion 711 provided with a first through hole 712, and the first through hole 712 is used for fixing the high temperature resistant wire segment 3. The second limiting portion 72 includes an end cover 721 provided with a second through hole for fixing the low temperature wire segment 4. In the present embodiment, the limiting protrusion 711 is provided with the first through hole 712. The high temperature resistant wire segment 3 passes through the first through hole 712 and extends into the accommodating space of the case 70. The limiting protrusion 711 fixes a position of the high temperature resistant wire segment 3 relative to the case 70, wherein a wall of the first through hole 712 presses against the high temperature resistant wire segment 3, thereby fixing the high temperature resistant wire segment 3. The end cover 721 is provided with the second through hole at a middle portion, and the low temperature wire segment 4 passes through the second through hole and extends into the accommodating space of the case 70. A wall of the second through hole presses against the low temperature wire segment 4, thereby fixing a position of the low temperature wire segment 4 relative to the case 70. By providing the first limiting portion 71 and the second limiting portion 72, the fixing of the high temperature resistant wire segment 3 and the low temperature wire segment 4 by means of the connecting member 7 is more stable, with a simple structure and reliable operation.

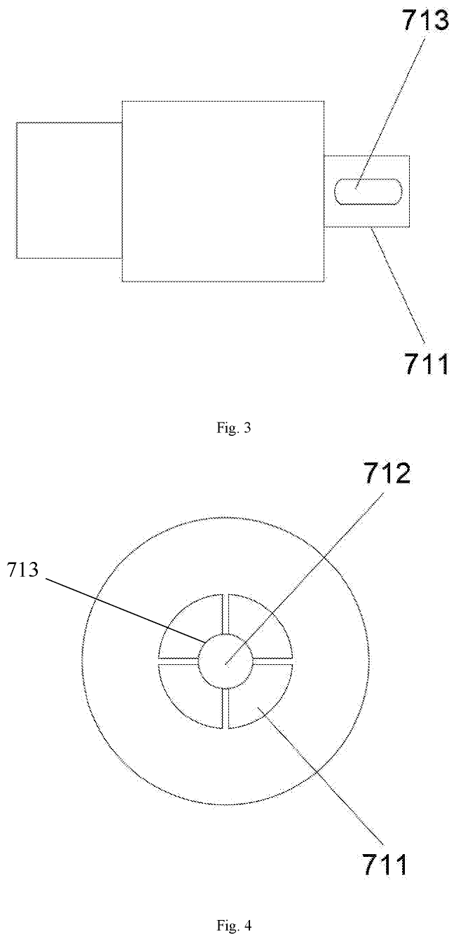

Continuing to refer to FIG. 3, as an alternative embodiment, the first limiting portion 71 includes one limiting protrusion 711. The one limiting protrusion 711 is provided with a recessed region 713 on one side of an outer peripheral surface for fixing the high temperature resistant wire segment 3. In the present embodiment, the high temperature resistant wire segment 3 extends across the recessed region 713, and the recessed region 713 can be used to make the high temperature resistant wire segment 3 to be more stable and less likely to move. The recessed region 713 is formed by recessing the outer peripheral surface of the limiting protrusion 711 inwardly, and may be formed by removing material from the limiting protrusion 711 in the process. The recessed region 713 has a simple structure and can be processed conveniently.

In the present embodiment, a fastener (not shown in the figures) may be provided on the outer peripheral surface of the limiting protrusion 711, and the fastener is disposed to at least locally contact with the outer peripheral surface of the first limiting portion 71 to shorten a perimeter of the outer peripheral surface of the first limiting portion 71, so that the wall of the first through hole 712 can be pressed against the high temperature resistant wire segment 3. In the case that the first limiting portion 71 includes one limiting protrusion 711, after the high temperature resistant wire segment 3 passes through the first through hole 712 and extends into the accommodating space of the case 70, the fastener is installed on the outer peripheral surface of the limiting protrusion 711 corresponding to the recessed region 713, so as to compress the limiting protrusion 711 and fix the high temperature resistant wire segment 3 on the limiting protrusion 711 more stably. As a result, the high temperature resistant wire segment 3 cannot be displaced or rotated easily.

Please continue to refer to FIG. 4, as an alternative embodiment, the first limiting portion 71 includes a plurality of limiting protrusions 711, and the plurality of limiting protrusions 711 are arranged in an annular form for fixing the high temperature resistant wire segment 3. At least one of the plurality of the limiting protrusions 711 is provided with a recessed region 713 on a side facing the remaining limiting protrusions 711 (that is, on an inner surface), for fixing the high temperature resistant wire segment 3. Specifically, each of the plurality of the limiting protrusions 711 is provided with the recessed region 713 on the side facing the remaining limiting protrusions 711, so as to define the first through hole 712. In the present embodiment, the plurality of limiting protrusions 711 are arranged annularly to form an annular member, and the high temperature resistant wire segment 3 passes through the annular member and extends into the accommodating space of the case 70. Thus, a position of the high temperature resistant wire segment 3 can be fixed by the annular member, so that the high temperature resistant wire segment 3 is stable relative to the case 70 and cannot be moved easily.

In the present embodiment, a fastener is provided on an outer peripheral surface of the limiting protrusion 711, and the fastener is disposed to at least locally contact with the outer peripheral surface of the first limiting portion 71 so as to shorten a perimeter of the outer peripheral surface of the first limiting portion 71, so that the wall of the first through hole 712 is pressed against the high temperature resistant wire segment 3. In the case that the first limiting portion 71 includes a plurality of limiting protrusions 711, the fastener of the present embodiment is located on the outer peripheral surface of the annular member constituted by the plurality of limiting protrusions 711. After the high temperature resistant wire segment 3 passes through the annular member, the fastener is installed on the outer peripheral surface of the annular member to close the plurality of limiting protrusions 711 to each other, thereby pressing against the high temperature resistant wire segment 3. As a result, the high temperature resistant wire segment 3 can be fixed by the plurality of limiting protrusions 711 more stably, and cannot be displaced or rotated easily, and the transmission can be performed stably.

As an alternative embodiment, the case 70 has a cross section in a circular or elliptical shape.

As an alternative embodiment, the case 70 extends in a curve. The case 70 of the present embodiment is bendable and has a certain curvature so that the cable can adapt to more layout situations.

In the above embodiments, the first limiting portion 71 is pressed against the high temperature resistant wire segment 3 by providing the fastener, to fix the high temperature resistant wire segment 3 stably. However, the embodiment of the present disclosure is not limited to this. Since both of the high temperature resistant wire segment 3 and the limiting protrusion 711 are made of metal, after the high temperature resistant wire segment 3 passes through the first through hole 712 of the first limiting portion 71, a crimping plier can be used to compress the limiting protrusion 711 from the outer peripheral surface thereof toward the high temperature resistant wire segment 3, so as to fix the limiting protrusion 711 and the high temperature resistant wire segment 3 together. Further, the limiting protrusion 711 and the high temperature resistant wire segment 3 can be fixed together by welding.

The high temperature resistant piezoelectric acceleration sensor according to an embodiment of the present disclosure includes a high temperature charge output device and a cable as described above, and the high temperature connection terminal 1 of the cable is connected to a signal output terminal of the high temperature charge output device. In the present embodiment, the high temperature connection terminal 1 of the cable is connected to the signal output terminal of the high temperature charge output device, and the low temperature connection terminal 2 of the cable can be connected to a signal input terminal of a signal collecting device. As such, the present high temperature resistant piezoelectric acceleration sensor can be used in a high temperature environment and can output a signal to a low temperature or normal temperature environment. On the one hand, a vibration signal of a mechanical system in the high temperature environment can be measured; on the other hand, a collection of the vibration signal in the low temperature or normal temperature region can be realized. In the present high temperature resistant piezoelectric acceleration sensor, the cable can be laid easily and has a low overall cost.

The above description is only the specific embodiment of the present disclosure, and the scope of the present disclosure is not limited thereto. The person skilled in the art can easily think of various equivalent modifications or substitutions within the technical scope disclosed by the present disclosure, which also fall within the protective scope of the present disclosure. Therefore, the protective scope of the present disclosure is defined by the scope of the claims.

What is claimed is:

1. A cable, comprising:
a high temperature connection terminal, a low temperature connection terminal, and a high temperature resistant wire segment and a low temperature wire segment located between the high temperature connection terminal and the low temperature connection terminal,
wherein the high temperature connection terminal is connected to the high temperature resistant wire segment, and the low temperature connection terminal is connected to the low temperature wire segment;
the high temperature resistant wire segment and the low temperature wire segment are connected by a connecting member; and
the low temperature wire segment has a bending radius smaller than that of the high temperature resistant wire segment, and the cable can be connected to a high temperature device via the high temperature connection terminal, and can be connected to a normal temperature device via the low temperature connection terminal.

2. The cable according to claim 1, wherein the high temperature resistant wire segment is made of INCONEL 600 or INCONEL 718, and the high temperature resistant wire segment has a temperature tolerance from 400° C. to 500° C.

3. The cable according to claim 1, wherein the high temperature resistant wire segment and the high temperature connection terminal are connected by a tin soldering, and the low temperature wire segment and the low temperature connection terminal are connected by a tin soldering.

4. The cable according to claim 1, wherein the connecting member comprises a case, wherein the case comprises openings at both ends and an internal accommodating space for containing an end portion of the high temperature resistant wire segment and an end portion of the low temperature wire segment; and
the end portion of the high temperature resistant wire segment and the end portion of the low temperature wire segment are connected by a nickel strip within the accommodating space.

5. The cable according to claim 4, wherein the end portion of the high temperature resistant wire segment is connected to the nickel strip by a tin soldering, and the end portion of the low temperature wire segment is connected to the nickel strip by a tin soldering.

6. The cable according to claim 4, wherein a high temperature resistant sealing portion is disposed within the accommodating space of the case, and the sealing portion is adapted to fix positions of the end portion of the high temperature resistant wire segment and the end portion of the low temperature wire segment connected to each other, and isolate the end portions from an exterior of the connecting member.

7. The cable according to claim 4, wherein a first limiting portion and a second limiting portion are respectively provided at the openings on both ends of the case, wherein the first limiting portion is adapted to fix the high temperature resistant wire segment, and the second limiting portion is adapted to fix the low temperature wire segment;
the first limiting portion comprises a limiting protrusion, and the limiting protrusion is provided with a first through hole for fixing the high temperature resistant wire segment; and
the second limiting portion comprises an end cover, and the end cover is provided with a second through hole for fixing the low temperature wire segment.

8. The cable according to claim 7, wherein the first limiting portion comprises one limiting protrusion and the one limiting protrusion is provided with a recessed region on one side for fixing the high temperature resistant wire segment.

9. The cable according to claim 7, wherein the first limiting portion comprises a plurality of limiting protrusions, and the plurality of limiting protrusions are arranged in an annular form for fixing the high temperature resistant wire segment, wherein at least one of the plurality of limiting protrusions is provided with a recessed region on a side facing the remaining limiting protrusions, for fixing the high temperature resistant wire segment.

10. The cable according to claim 7, wherein a fastener is provided on an outer peripheral surface of the limiting protrusion, and the fastener is adapted to shorten a perimeter of an outer peripheral surface of the first limiting portion.

11. The cable according to claim 7, wherein the first limiting portion and the high temperature resistant wire segment are fixed together by welding.

12. The cable according to claim 7, wherein the first limiting portion and the high temperature resistant wire segment are fixed together by using a crimping plier to press the first limiting portion against the high temperature resistant wire segment.

13. A high temperature resistant piezoelectric acceleration sensor, comprising:
a high temperature charge output device and a cable according to claim 1,
wherein the high temperature connection terminal of the cable is connected to a signal output terminal of the high temperature charge output device.

14. The cable according to claim 13, wherein the high temperature resistant wire segment is made of INCONEL 600 or INCONEL 718, and the high temperature resistant wire segment has a temperature tolerance from 400° C. to 500° C.

15. The cable according to claim 13, wherein the high temperature resistant wire segment and the high temperature connection terminal are connected by a tin soldering, and the low temperature wire segment and the low temperature connection terminal are connected by a tin soldering.

16. The cable according to claim 13, wherein the connecting member comprises a case, wherein the case comprises openings at both ends and an internal accommodating space for containing an end portion of the high temperature resistant wire segment and an end portion of the low temperature wire segment; and
the end portion of the high temperature resistant wire segment and the end portion of the low temperature wire segment are connected by a nickel strip within the accommodating space.

17. The cable according to claim 16, wherein the end portion of the high temperature resistant wire segment is connected to the nickel strip by a tin soldering, and the end portion of the low temperature wire segment is connected to the nickel strip by a tin soldering.

18. The cable according to claim 16, wherein a high temperature resistant sealing portion is disposed within the accommodating space of the case, and the sealing portion is adapted to fix positions of the end portion of the high temperature resistant wire segment and the end portion of the low temperature wire segment connected to each other, and isolate the end portions from an exterior of the connecting member.

19. The cable according to claim 16, wherein a first limiting portion and a second limiting portion are respectively provided at the openings on both ends of the case, wherein the first limiting portion is adapted to fix the high temperature resistant wire segment, and the second limiting portion is adapted to fix the low temperature wire segment;
the first limiting portion comprises a limiting protrusion, and the limiting protrusion is provided with a first through hole for fixing the high temperature resistant wire segment; and
the second limiting portion comprises an end cover, and the end cover is provided with a second through hole for fixing the low temperature wire segment.

20. The cable according to claim 19, wherein the first limiting portion comprises one limiting protrusion and the one limiting protrusion is provided with a recessed region on one side for fixing the high temperature resistant wire segment.
